(19) United States
(12) Patent Application Publication
(10) Pub. No.: US 2010/0139597 A1
(43) Pub. Date: Jun. 10, 2010

(54) APPARATUS AND METHODS FOR CONDITIONING FUEL TO INCREASE THE GAS MILEAGE OF AN INTERNAL COMBUSTION ENGINE

(76) Inventors: Ronald P. Wisdom, Glendale, AZ (US); Wilbert C. Powe, JR., Avondale, AZ (US); Michael G. Wilmoth, Chandler, AZ (US)

Correspondence Address: MICHAEL WINFIELD GOLTRY, 4000 N. CENTRAL AVENUE, SUITE 1220, PHOENIX, AZ, 85012, US

(21) Appl. No.: 12/630,504

(22) Filed: Dec. 3, 2009

Related U.S. Application Data
(60) Provisional application No. 61/200,976, filed on Dec. 5, 2008.

(51) Int. Cl. F02B 43/00; F02B 43/08

(52) U.S. Cl. 123/1 A; 123/3

(57) ABSTRACT

An apparatus for conditioning fuel includes an enclosure that maintains a void and an opposed volume of an electrolytic solution, and an electrically charged electrode structure positioned in the volume of the electrolytic solution generating electrolysis in the electrolytic solution to produce hydrogen gas that passes into the void from the electrolytic solution. A fuel supply line of an internal combustion engine is coupled in gaseous communication with the void to receive the hydrogen gas from the void and apply the hydrogen gas to fuel flowing through the fuel supply line to condition the fuel with the hydrogen gas.

### CROSS REFERENCE TO RELATED APPLICATION

This application claims the benefit of U.S. Provisional Patent Application Ser. No. 61/200,976, filed Dec. 5, 2008.

### FIELD OF THE INVENTION

The present invention relates to internal combustion engines and, more particularly, to apparatus and methods for improving the gas mileage of internal combustion engines.

### BACKGROUND OF THE INVENTION

Gasoline and diesel internal combustion engines utilize the exothermic chemical process of combustion of an ignition gas in the form of an air-fuel mixture to act against a reciprocating piston in a combustion chamber of a cylinder of a cylinder or piston assembly to impart rotation to a crank shaft operatively coupled to the piston. Almost all vehicle engines utilize a four-process, or four-stroke combustion cycle to convert fuel into motion, which includes the intake process or stroke, the compression process or stroke, the expansion or combustion process or stroke, and the exhaust process or stroke. The expansion or combustion process or stroke is the power process or stroke of the combustion cycle.

In a four-stroke gasoline engine, the combustion cycle begins with the piston at the top of the cylinder defining the minimum volume of the combustion chamber in the cylinder. At this starting position, the piston moves from the top of the cylinder to the bottom of the cylinder to intake ignition gas, which is the intake process or intake stroke. When the piston is at the bottom of its intake stroke and the end of the intake process, the volume of the combustion chamber in the cylinder is maximized and is filled with a charge of ignition gas. At the bottom of the intake stroke or process, the piston commences the compression stroke or process moving from the bottom of the cylinder to the top of the cylinder defining the minimum volume of the combustion chamber in the cylinder compressing the charge of ignition gas in the combustion chamber of the cylinder. When the piston reaches the top of its compression stroke completing the compression process, the compressed charge of ignition gas is ignited with a spark from a spark plug, and the resulting explosion acts against the piston initiating the combustion stroke or process driving the piston down in the combustion stroke or process of the piston from the top of the cylinder to the bottom of the cylinder. When the piston reaches the bottom of its combustion stroke to complete the combustion stroke or process at the bottom of the cylinder defining the maximum volume of the combustion chamber, the combustion chamber is filled with exhaust gas and the piston commences the exhaust stroke or process moving from the bottom of the cylinder to the top of the cylinder to exhaust the exhaust gas from the cylinder into the exhaust system or tailpipe, at which point the intake stroke or process of the next four-stroke cycle commences and this process continues as before. Accordingly, in a gasoline engine, fuel is mixed with air to form ignition gas, which is compressed by pistons and ignited by sparks from spark plugs. Diesel engines also utilize this four-stroke four-process combustion cycle. In a diesel engine, however, the air is compressed first, and then the fuel is injected. Because air heats up when compressed, the fuel ignites when it is injected into the cylinder. Two-stroke engines also operate under the four-process combustion cycle consisting of the intake, compression, combustion, and exhaust processes, but only through two strokes of the piston rather than four strokes as in a conventional four-stroke engine. Some engines, such as Seiliger or Sabathe engines, utilize a dual or mixed combustion cycle, which is a thermal cycle that is a combination of the Otto cycle and the Diesel cycle.

The measure of engine efficiency usually involves a comparison of the total chemical energy in the fuel, and the useful energy abstracted from the fuel in the form of kinetic energy. The most fundamental and abstract discussion of engine efficiency is the thermodynamic limit for abstracting energy from the fuel defined by a thermodynamic cycle. The most comprehensive is the empirical fuel economy of the total engine system for accomplishing a desired task.

Internal combustion engines are primarily heat engines. As such, the phenomenon that limits their efficiency is described by the thermodynamic cycles. None of these cycles exceed the limit defined by the Carnot cycle, which states that the overall thermal efficiency is dictated by the difference between the lower and upper operating temperatures of the engine. A terrestrial engine is usually and fundamentally limited by the upper thermal stability derived from the material used to make up the engine. All metals and metal alloys eventually melt or decompose and there is significant researching into ceramic materials that can be made with higher thermal stabilities and desirable structural properties. Higher thermal stability allows for greater temperature difference between the lower and upper operating temperatures, thus greater thermodynamic efficiency.

The thermodynamic limits assume that the engine is operating in ideal conditions, which includes the combustion of ideal fuel. Engines run best at specific loads and rates as described by their power curve. For example, a car cruising on a highway is usually operating significantly below its ideal load, because the engine is designed for the higher loads desired for rapid acceleration. The applications of engines are used as contributed drag on the total system reducing overall efficiency, such as wind resistance designs for vehicles. These and many other losses result in the actual fuel economy of the engine that is usually measured in the units of miles per gallon or kilometers per liter for automobiles. The distance traveled for each gallon of fuel consumed represents a meaningful amount of work and the volume of hydrocarbon implies a standard energy content. Most internal combustion engines have a thermodynamic limit of approximately 40%. Even when aided with turbochargers and stock efficiency aids, most engines retain an average efficiency of about 18%-20%.

Many attempts have been made to increase the efficiency of internal combustion engines. In general, practical engines are always compromised by trade-offs between different properties such as efficiency, weight, exhaust emissions, or noise. Sometimes economy also plays a role in not only in the cost of manufacturing the engine itself, but also manufacturing and distributing the fuel. Increasing the engines' efficiency brings better fuel economy but only if the fuel cost per energy content is the same.

Although skilled artisans have devoted considerable research and development resources toward systems designed to reduce fuel consumption and fuel combustion emissions in internal combustion engines, little if any attention has been directed simply toward improving the total chemical energy in the fuel to increase the useful energy abstracted from the fuel in the form of kinetic energy and improving the overall combustion of the fuel in the combustion cycle in order to improve engine efficiency, reduce harmful fuel consumption, reduce fuel combustion emissions, and improve gas mileage.

### SUMMARY OF THE INVENTION

According to the principle of the invention, an apparatus for conditioning fuel to an internal combustion engine for improving the gas mileage of the internal combustion engine includes an enclosure that maintains a void, an opposed volume of an electrolytic solution, and an electrically charged electrode structure positioned in the volume of the electrolytic solution generating electrolysis in the electrolytic solution to produce hydrogen gas that passes into the void from the electrolytic solution. A fuel supply line of an internal combustion engine is coupled in gaseous communication with the void to receive the hydrogen gas from the void and apply the hydrogen gas to fuel flowing through the fuel supply line to condition the fuel with the hydrogen gas to improve the gas mileage of the internal combustion engine. The enclosure consists of an upstanding, continuous sidewall having a closed upper end and an opposed closed lower end that cooperate to form an enclosed chamber defining an upper region proximate to the upper end and an opposed lower region proximate to the lower end. The void is formed in the upper region of the enclosed chamber and the volume of the electrolytic solution is formed in the lower region of the enclosed chamber. The electrode structure is attached to the upstanding continuous sidewall, and is suspended in the volume of the electrolytic solution between the upper and lower closed ends of the enclosure. The electrode structure includes a plurality of interconnected and electrically isolated, spaced apart, substantially parallel conductive plates. In one embodiment, the fuel supply line is coupled in gaseous communication with the void with an outlet formed in the continuous sidewall proximate to the closed upper end of the enclosure, and a hydrogen gas line coupled between the outlet and the fuel supply line to receive the hydrogen gas from the void via the outlet and convey the hydrogen gas to the fuel supply line. In this embodiment, the outlet is formed with a shield extending into the void from the upstanding, continuous sidewall, which extends upwardly toward the closed upper end of the enclosure and away from the volume of the electrolytic solution to inhibit the electrolytic solution from spilling into the outlet. In another embodiment, the fuel supply line is coupled in gaseous communication with the void with an outlet formed in the closed upper end of the enclosure, and a hydrogen gas line coupled between the outlet and the fuel supply line to receive the hydrogen gas from the void via the outlet and convey the hydrogen gas to the fuel supply line.

According to the principle of the invention, a method of conditioning fuel to an internal combustion engine for improving the gas mileage of the internal combustion engine includes providing a source of hydrogen gas, and coupling a fuel supply line of an internal combustion engine in gaseous communication with the source of hydrogen gas to receive hydrogen gas from the source of hydrogen gas and apply the hydrogen gas to fuel flowing through the fuel supply line to condition the fuel with the hydrogen gas. The step of providing the source of hydrogen gas preferably includes providing an enclosure maintaining a void and an opposed volume of an electrolytic solution, and an electrically charged electrode structure positioned in the volume of the electrolytic solution generating electrolysis in the electrolytic solution to produce hydrogen gas that passes into the void from the electrolytic solution. The step of coupling the fuel supply line of the internal combustion engine in gaseous communication with the source of hydrogen gas to receive the hydrogen gas from the source of hydrogen gas and apply the hydrogen gas to fuel flowing through the fuel supply line includes coupling the fuel supply line of the internal combustion engine in gaseous communication with the void to receive the hydrogen from the void and apply the hydrogen gas to fuel flowing through the fuel supply line. The enclosure consists of an upstanding, continuous sidewall having a closed upper end and an opposed closed lower end that cooperate to form an enclosed chamber defining an upper region proximate to the upper end and an opposed lower region proximate to the lower end, in which the void is formed in the upper region of the enclosed chamber and the volume of the electrolytic solution is formed in the lower region of the enclosed chamber. The electrode structure is preferably attached to the upstanding continuous sidewall, and is suspended in the volume of the electrolytic soluti The electrode structure consists of a plurality of interconnected and electrically isolated, spaced apart, substantially parallel conductive plates. In accordance with one embodiment of the invention, the step of coupling the fuel supply line of the internal combustion engine in gaseous communication with the void to receive the hydrogen from the void and apply the hydrogen gas to fuel flowing through the fuel supply line further includes forming an outlet in the continuous sidewall proximate to the closed upper end of the enclosure, and coupling the outlet to the fuel supply line in gaseous communication with a hydrogen gas line to receive the hydrogen gas from the void via the outlet and convey the hydrogen gas to the fuel supply line. In this embodiment, the method next includes forming the outlet with a shield extending into the void from the upstanding, continuous sidewall, which extends upwardly toward the closed upper end of the enclosure and away from the volume of the electrolytic solution to inhibit the electrolytic solution from spilling into the outlet. In a further embodiment of the invention, the step of coupling the fuel supply line of the internal combustion engine in gaseous communication with the void to receive the hydrogen from the void and apply the hydrogen gas to fuel flowing through the fuel supply line further includes forming an outlet in the closed upper end of the enclosure, and coupling the outlet to the fuel supply line in gaseous communication with a hydrogen gas line to receive the hydrogen gas from the void via the outlet and convey the hydrogen gas to the fuel supply line.

Consistent with the foregoing summary of preferred embodiments, and the ensuing detailed description, which are to be taken together, the invention also contemplates associated apparatus and method embodiments.

### BRIEF DESCRIPTION OF THE DRAWINGS

Referring to the drawings:

FIG. 1 is a perspective view of an apparatus for conditioning fuel to an internal combustion engine;

FIG. 2 is a top plan view of the apparatus of FIG. 1;

FIG. 3 is a side elevation view of the apparatus of FIG. 1;

FIG. 4 is a section view taken along line 4-4 of FIG. 3;

FIG. 5 is a section view taken along line 5-5 of FIG. 2;

FIG. 6 is an exploded perspective view of an electrode structure of the apparatus of FIG. 1;

FIG. 7 is a section view taken along line 7-7 of FIG. 5 illustrating an outlet of the apparatus;

FIG. 8 is side elevation view of the apparatus of FIG. 1 shown as it would appear coupled in gaseous communication to a fuel line of an internal combustion engine with a hydrogen gas line;

FIG. 9 is a view similar to that of FIG. 7 illustrating the outlet shown as it would appear coupled to the hydrogen gas line of FIG. 8;

FIG. 10 is a side elevation view of an alternate embodiment of an apparatus for conditioning fuel to an internal combustion engine;

FIG. 11 is a top plan view of the apparatus of FIG. 10;

FIG. 12 is a section view taken along line 12-12 of FIG. 10; and

FIG. 13 is a section view taken along line 13-13 of FIG. 11.

### DETAILED DESCRIPTION

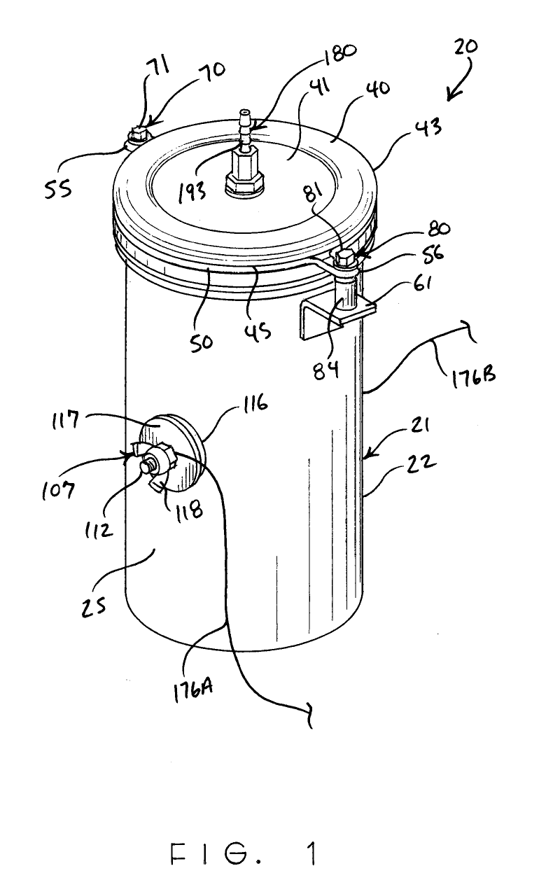

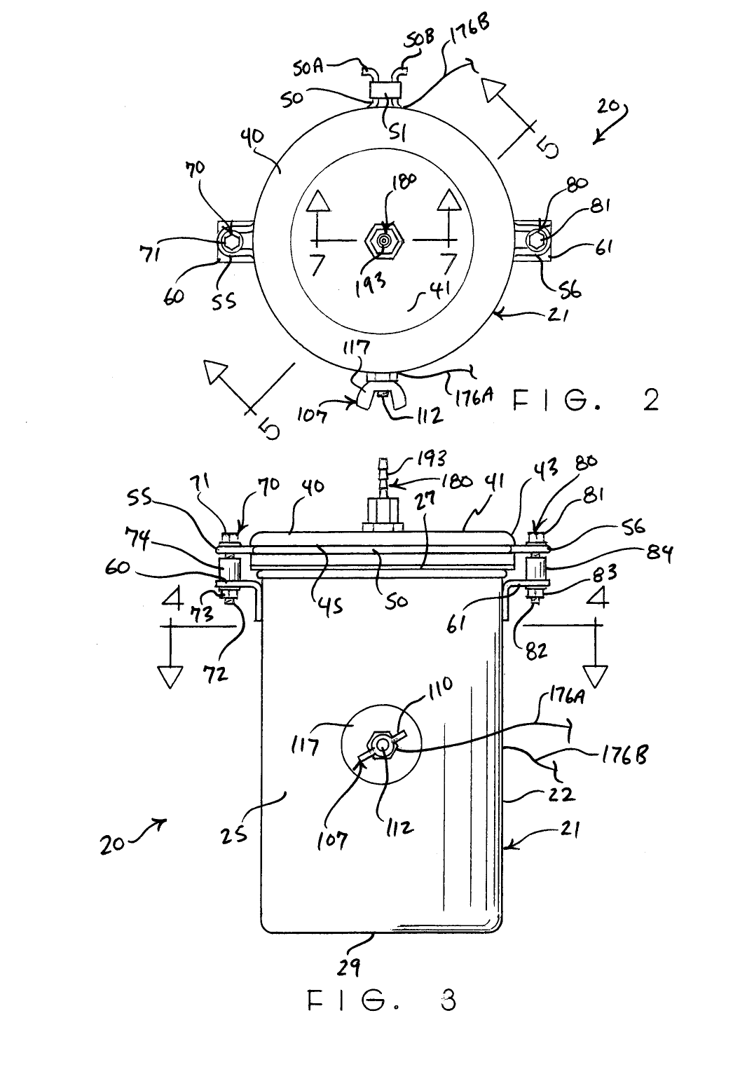

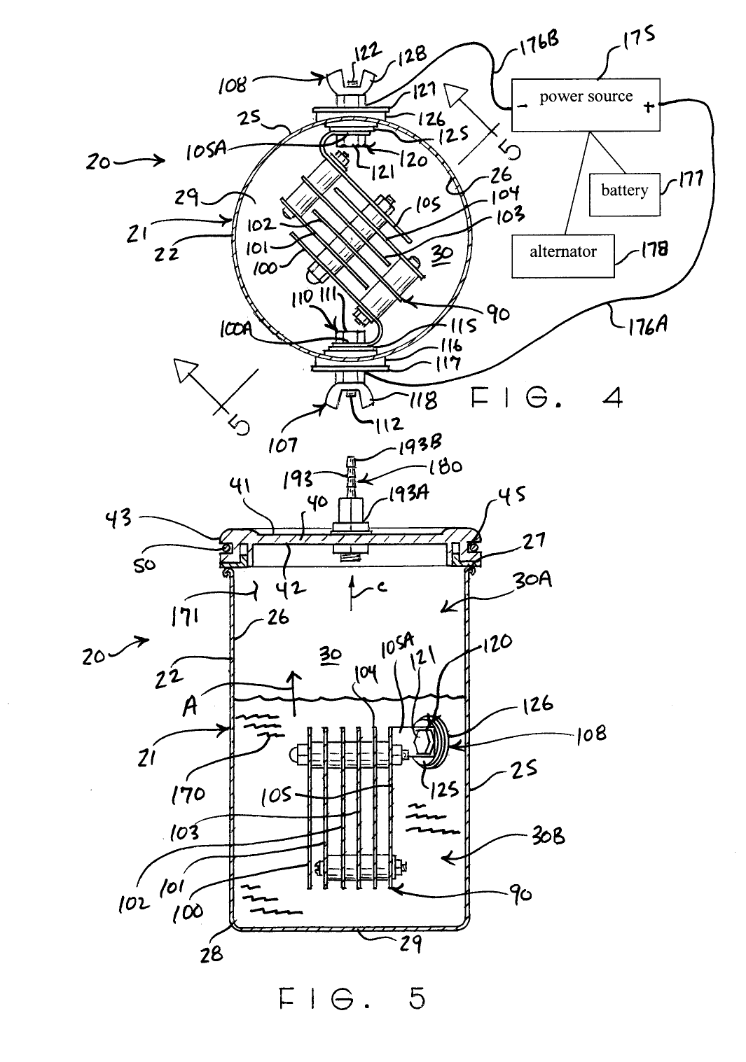

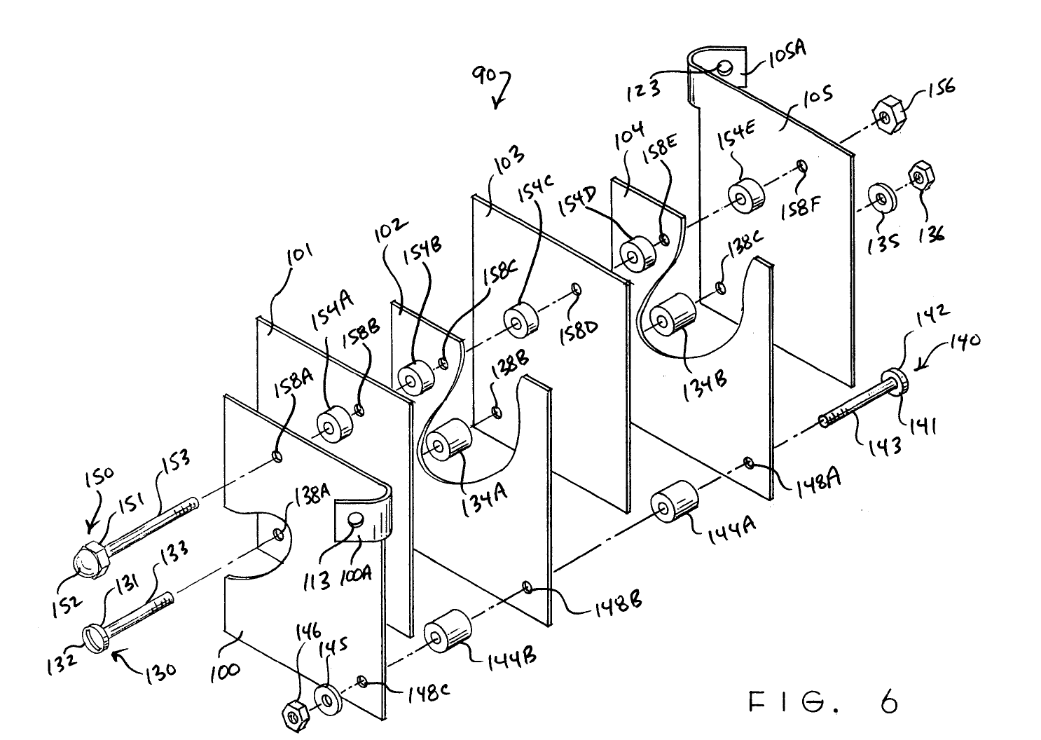

Turning now to the drawings, in which like reference characters indicate corresponding elements throughout the several views, attention is first directed to FIG. 1 in which there is seen a perspective view of an apparatus 20 for conditioning fuel to improve the total chemical energy in the fuel to increase the useful energy abstracted from the fuel in the form of kinetic energy and improving the overall combustion of the fuel in the combustion cycle of an internal combustion engine in order to improve engine efficiency, reduce harmful fuel consumption, reduce fuel combustion emissions, and improve gas mileage of an internal combustion engine. For reference purposes, FIG. 2 is a top plan view of apparatus 20, FIG. 3 is a side elevation view of apparatus 20, FIG. 4 is a section view of apparatus 20 taken along line 4-4 of FIG. 3, and FIG. 5 is a section view of apparatus 20 taken along line 5-5 of FIG. 2.

Referencing FIG. 5, apparatus 20 consists of an enclosure or container denoted generally at 21 that includes an upstanding continuous sidewall 22 having opposed outer and inner surfaces 25 and 26, an upper edge 27, an opposed lower edge 28, and a substantially horizontal bottom 29 affixed to lower edge 28 forming a closed bottom or lower end of enclosure 21. Bottom 29 cooperates with inner surface 26 of sidewall 22 to form a fluid impervious receptacle denoted generally at 30. Enclosure 21 also includes a substantially horizontal lid or top 40. Lid or top 40 is secured to enclosure 21, and is preferably removably secured to enclosure with a fastening system, and, more particularly, is attached to upper edge 27 forming a closed top or upper end of enclosure 21 opposing the closed bottom or lower end of enclosure 21 formed by bottom 29. Inner surface 26 of sidewall 22, closed bottom formed by bottom 29, and closed top formed by top 40 cooperate to enclose receptacle 30. Enclosure 21 is preferably fabricated of a metal, ceramic, plastic, or other rigid material or combination of rigid materials, and is, overall, generally cylindrical in shape.

Top 40 is broad and flat and includes an outer surface 41, an opposed inner surface 42 facing inwardly toward receptacle 30, and a perimeter edge 43. Perimeter edge 43 is formed with an inwardly directed annular groove 45. A wire 50 is received in groove 45. Wire 50 is preferably formed of metal, such as spring steel, and has opposed tag ends 50A and 50B that project outwardly with respect to perimeter edge 43 of top 40 as illustrated in FIG. 2, and are captively retained by a rigid collar 51 formed preferably of aluminum, steel, or the like. Tag ends 50A and 50B are outturned with respect to each other and with respect to collar 51 to prevent collar 51 from dislodging from tag ends 50A and 50B. From tag ends 50A and 50B, wire 50 is applied to groove 45 as illustrated in FIGS. 1, 3, and 5, formed in perimeter 43 of top 40 and encircles top 40 along perimeter 43.

Wire 50 forms part of the fastening system securing top 40 to enclosure 21 in the present embodiment, as is a fastening structure securing wire 50 to sidewall 22 to captively retain top 40 with respect to upper edge 27. Referencing FIGS. 2 and 3, the fastening structure formed between wire 50 and sidewall 22 includes opposed brackets 60 and 61 formed with sidewall 22. Looking specifically to FIG. 3, brackets 60 and 61 project outwardly from outer surface 25 of sidewall 22 just below upper edge 27 and top 40. Brackets 60 and 61 are rigidly affixed to outer surface 25 of sidewall 22 preferably by welding, and rivets, bolts, or other like or similar fasteners may be used if so desired. Brackets 60 and 61 can also be integrally formed with sidewall 22, if so desired. As shown in FIG. 2, wire 50 is formed with opposed loops 55 and 56 forming part of the fastening structure between wire 50 and sidewall 22. Loop 55 is positioned above and opposes bracket 60 and is secured to bracket 60 with a fastener of the fastening system, and loop 56 is positioned above and opposes bracket 61 and is secured to bracket 61 with another fastener of the fastening system.

Referencing FIG. 3, the fastener securing loop 55 to bracket 60 consists of a nut-and-bolt assembly including a bolt 70 having a bolt head 71 and a threaded shank 72. Bolt head 71 is positioned against the upper side of loop 55 formed in wire 50. Threaded shank 72 extends downwardly from bolt head 71 through loop 55 and into and through an opening formed in bracket 60 and is threadably secured to a nut 73 positioned against the underside of bracket 60. Nut 73 is tightened to secure loop 55 and bracket 60 between bolt head 71 and nut 73. A spacer 74 encircles threaded shank 72 between loop 55 and bracket 60, which limits the deflection between loop 55 and bracket 60 to prevent the bolt assembly between loop 55 and bracket 60 from being overtightened. The fastener securing loop 56 to bracket 61 consists of a nut-and-bolt assembly including a bolt 80 having a bolt head 81 and a threaded shank 82. Bolt head 81 is positioned against the upper side of loop 56 formed in wire 50. Threaded shank 82 extends downwardly from bolt head 81 through loop 56 and into and through an opening formed in bracket 61 and is threadably secured to a nut 83 positioned against the underside of bracket 61. Nut 83 is tightened to secure loop 56 and bracket 61 between bolt head 81 and nut 83. A spacer 84 encircles threaded shank 82 between loop 56 and bracket 61, which limits the deflection between loop 56 and bracket 61 to prevent the bolt assembly between loop 56 and bracket 61 from being overtightened. By tightening nuts 73 and 83 of the bolt assemblies formed between loops 55 and 56 and brackets 60 and 61, respectively, loops 55 and 56 are urged toward brackets 60 and 61, which causes wire 50 to act on top 40 at groove 45 formed in perimeter 43 of top 40 urging top 40 downwardly against upper edge 27 of sidewall 22 to securely attach top 40 to upper edge 27 of sidewall 22. As seen in FIG. 4, an annular gasket 47 is formed between top 40 and upper edge 27 of sidewall 22, which forms a substantially fluid-impervious seal between top 40 and upper edge 27 of sidewall 22. Nuts 73 and 83 may be loosened and removed from the respective bolts 70 and 80 to allow for the removal of top 40 from enclosure 21 to provide access into receptacle 30.

Referencing FIGS. 4 and 5, enclosure 21 maintains an electrode structure, which is denoted generally at 90 and which functions to receive an electric current to generate electrolysis in an electrolytic solution to produce hydrogen gas, in accordance with the principle of the invention. Electrode structure 90 is positioned in receptacle 30, and is thereby enclosed in enclosure 21. Electrode structure 90 is attached to sidewall 22 in the preferred embodiment, and is held or otherwise suspended in receptacle 30 between the closed bottom formed by bottom 29 of enclosure 21 and the closed top formed by top 40 of enclosure 21. Receptacle 30 enclosed by enclosure 21 has an upper region 30A formed proximate to top 40, and an opposed lower region 30B formed proximate to bottom 29. Electrode structure 90 is positioned in lower region 30B proximate to bottom 29 as best illustrated in FIG. 5.

Looking to FIG. 4, electrode structure 90 includes a plurality of interconnected and electrically isolated, spaced apart, substantially parallel conductive plates 100-105. With additional reference to FIG. 6, which is an exploded perspective view of electrode structure 90, plates 102-104 are positioned between plates 100 and 105. As such, plates 100 and 105 are outermost plates of electrode structure 90, and plates 102-104 positioned between outermost plates 100 and 105 are inner or intermediate plates of electrode structure 90. Plates 100-105 are substantially equal in size and shape, and are formed of conductive material, such as copper, steel, or other conductive material or combination of conductive materials. Outermost plates 100 and 105 area each coupled to sidewall 22, inner plates 101-104 are, in turn, coupled to and supported by and between outermost plates 100 and 105, and plates 100-105 forming electrode structure 90 are electrically isolated from enclosure 21, and plates 100-105 are electrically isolated with respect to each other.

Referring in relevant part to FIG. 4 and also to FIG. 6, which is an exploded perspective view of electrode structure 90, outermost plate 100 is formed with a tab 100A, which is secured to sidewall 22 with a fastener system 107 and which is electrically connected to fastener system 107 and electrically isolated from enclosure 21. Fastener system 107 securing tab 100A with respect to sidewall 22 is electrically conductive and electrically connects tab 100A, and includes a fastener consisting of a nut-and-bolt assembly including a bolt 110 having a bolt head 111 and a threaded shank 112, all of which are formed of steel or other electrically conducting material or combination of materials. Bolt head 111 is positioned against the inner side of tab 100A formed in outermost plate 100. Threaded shank 112 extends outwardly from bolt head 111 through an opening 113 (FIG. 6) in tab 100A, through a washer 115 positioned against the inner side of an electrically-insulating grommet 116 formed in an opening extending through sidewall 22, through the opening in sidewall 22 through grommet 116, through a washer 117 positioned against the outer side of grommet 116 exteriorly of outer surface 25 of sidewall 22, and is threadably secured to a wing nut 118 positioned against washer 117 located between wing nut 118 and the outer side of grommet 116. Nut 118 is tightened to securing the fastener system to secure tab 100 between bolt head 111 and washer 115 positioned between tab 100A and the inner side of grommet 116 and clamping grommet 116 to sidewall 22. Grommet 116 is made of rubber or other electrically insulating material electrically isolating the fastener system securing outermost plate 100 to sidewall 22 with respect to enclosure 21, and also providing a substantially fluid impervious seal at the opening through sidewall 22 at which grommet 116 is installed. An electric current applied to bolt 110 runs through bolt 110 to tab 100A and to outermost plate 100.

With continuing reference to FIGS. 4 and 6 in relevant part, outermost plate 105 is formed with a tab 105A, which is secured to sidewall 22 with a fastener system 108 and which is electrically connected to fastener system 107 and electrically isolated from enclosure 21. Fastener system 108 securing tab 105A to sidewall 22 is electrically conductive and electrically connects tab 105A, and includes a fastener consisting of a nut-and-bolt assembly including a bolt 120 having a bolt head 121 and a threaded shank 122, all of which are formed of steel or other electrically conducting material or combination of materials. Bolt head 121 is positioned against the inner side of tab 105A formed in outermost plate 105. Threaded shank 122 extends outwardly from bolt head 121 through an opening 123 (FIG. 6) in tab 105A, through a washer 125 positioned against the inner side of an electrically-insulating grommet 126 formed in an opening extending through sidewall 22, through the opening in sidewall 22 through grommet 126, through a washer 127 positioned against the outer side of grommet 126 exteriorly of outer surface 25 of sidewall 22, and is threadably secured to a wing nut 128 positioned against washer 127 located between wing nut 128 and the outer side of grommet 126. Nut 128 is tightened to securing the fastener system to secure tab 105 between bolt head 121 and washer 125 positioned between tab 105A and the inner side of grommet 126 and clamping grommet 126 to sidewall 22. Grommet 126 is made of rubber or other electrically insulating material electrically isolating the fastener system securing outermost plate 105 to sidewall 22 with respect to enclosure 21, and also providing a substantially fluid impervious seal at the opening through sidewall 22 at which grommet 126 is installed. An electric current applied to bolt 120 runs through bolt 120 to tab 105A and to outermost plate 105.

As previously mentioned, inner plates 101-104 are coupled to and supported by and between outermost plates 100 and 105 and are electrically isolated with respect to each other and with respect to outermost plates 100 and 105. To discuss this, reference is made to FIG. 6, in which portions of outermost plate 100 and inner plates 102 and 104 are broken away for illustrative purposes. In general, plates 100-105 are coupled together with fasteners that extend through and between plates and that extend through spacers positioned between each pair of opposed plates maintaining plates 100-105 in a spaced apart, parallel relation. In the present embodiment there are three fastener systems 130, 140, and 150 in electrode structure 90 electrically isolating and securing plates 100-105 together. Fastener system 130 couples plates 101, 103, and 105, fastener system 140 couples plates 100, 102, and 104, and fastener system 150 couples plates 100-105.

Fastener system 130 includes a bolt 131, having a bolt head 132 and a threaded shank 133, spacers 134A and 134B, a washer 135, and a nut 136. Bolt head 132 is positioned against the outer side of plate 101, and shank 133 extends concurrently through openings 138A, 138B, and 138C formed in plates 101, 103, and 105, respectively, spacer 134A positioned between plates 101 and 103, spacer 134B between plates 103 and 105, and washer 135 positioned on the outer side of plate 105. Threaded shank 133 is threadably secured to nut 136 positioned against washer 135 on the outer side of plate 105, and nut 136 is tightened against washer 135 clamping together and securing plates 101, 103, and 105, and spacers 134A and 134B between washer 135 and bolt head 132. Bolt 131, washer 135, nut 136 and spacers 134A and 134B are non-conductive, and are formed of plastic, ceramic, or other non-conductive material or combination of materials. Spacer 134A is in intimate contact with plates 101 and 103, spacer 134B is in intimate contact with plates 103 and 105, and spacers 134A and 134B maintain plates 101, 103, and 105 in a spaced apart, parallel relation. Because bolt 131, washer 135, nut 136 and spacers 134A and 134B coupling plates 101, 103, and 105 are non-conductive, plates 101, 103, and 105 are electrically isolated with respect to each other.

Fastener system 140 includes a bolt 141, having a bolt head 142 and a threaded shank 143, spacers 144A and 144B, a washer 145, and a nut 146. Bolt head 142 is positioned against the outer side of plate 104, and shank 143 extends concurrently through openings 148A, 148B, and 148C formed in plates 104, 102, and 100, respectively, spacer 144A positioned between plates 104 and 102, spacer 144B between plates 102 and 100, and washer 145 positioned on the outer side of plate 100. Threaded shank 143 is threadably secured to nut 146 positioned against washer 145 on the outer side of plate 100, and nut 146 is tightened against washer 145 clamping together and securing plates 104, 102, and 100, and spacers 144A and 144B between washer 145 and bolt head 142. Bolt 141, washer 145, nut 146, and spacers 144A and 144B are non-conductive, and are formed of plastic, ceramic, or other non-conductive material or combination of materials. Spacer 144A is in intimate contact with plates 104 and 102, and spacer 144B is in intimate contact with plates 102 and 100 maintaining plates 104, 102, and 100 in a spaced apart, parallel relation. Because bolt 141, washer 145, nut 146, and spacers 144A and 144B coupling plates 104, 102, and 100 are nonconductive, plates 104, 102, and 100 are electrically isolated with respect to each other.

Fastener system 150 includes a bolt 151, having a bolt head 152 and a threaded shank 153, spacers 154A-E, and a nut 156. Bolt head 152 is positioned against the outer side of plate 100, and shank 153 extends concurrently through openings 158A-E formed in plates 100-105, respectively, spacer 154A positioned between plates 100 and 101, spacer 154B between plates 101 and 102, spacer 154C between plates 102 and 103, spacer 154D between plates 103 and 104, and spacer 154E between plates 104 and 105. Threaded shank 153 is threadably secured to nut 156 positioned against the outer side of plate 105, and nut 156 is tightened against the outer side of plate 105 clamping together and securing plates 100-105, and spacers 154A-E between washer nut 156 and bolt head 152. Bolt 151, nut 156, and spacers 154A-E are non-conductive, and are formed of plastic, ceramic, or other non-conductive material or combination of materials. Spacer 154A is in intimate contact with plates 100 and 101, spacer 154B is in intimate contact with plates 101 and 102, spacer 154C is in intimate contact with plates 102 and 103, spacer 154D is in intimate contact with plates 103 and 104, and spacer 154E is in intimate contact with plates 104 and 105, such that spacers 154A-E maintain plates 100-105 in a spaced apart, parallel relation. Because bolt 151, nut 156, and spacers 154A-E coupling plates 100-105 are non-conductive, plates 100-105 are electrically isolated with respect to each other.

In the present embodiment there are three fastener systems 130, 140, and 150 in electrode structure 90 electrically isolating and securing plates 100-105 together, and there are six plates 100-105 in electrode structure 90, and less or more fastener systems and less or more plates may be used without departing from the invention.

Looking back now to FIG. 5, a volume of an electrolytic solution 170 is provided, and is applied to receptacle 30 enclosed by enclosure 21 so as to fill lower region 30B and submerge electrode structure 90 therein forming a void in receptacle at upper region 30A denoted generally at 171, in accordance with the principle of the invention. The fluid impervious character of receptacle 30, including the fluid impervious seal between top 40 and upper edge 27 of sidewall 22 and between fastener systems 107 and 108 and sidewall 22 prevent solution 170 from leaking outwardly with respect to enclosure 21. Solution 170 is characterized in that it allows electrical conductivity between plates 100-105 of electrode structure 90 to produce electrolysis in solution 170 in response to an electric current applied electrode structure 90, such as to either or both of outermost plates 100 and 105 of electrode structure 90, to generate hydrogen gas, which rises from solution 170 maintained in lower region 30B of receptacle to void 171 formed in upper region 30A of receptacle 30 in the direction indicated by arrowed line A.

In accordance with a preferred embodiment, solution 170 is an aqueous electrolytic solution consisting of a mixture of sodium bicarbonate dissolved in water at a ratio of approximately 1 part sodium bicarbonate dissolved in approximate 800 parts of water, and other ratios may be used suitable to allow electrical conductivity between plates 100-105 of electrode structure 90 to produce electrolysis in solution 170 in response to a current applied to electrode structure 90 to generate hydrogen gas. Although a solution of sodium bicarbonate and water is preferred for solution 170, other suitable electrolytic solutions may be used without departing from the invention so as to produce hydrogen gas by electrolysis.

To apply an electric current to electrode structure 90, electrode structure 90 is electrically connected to receive an electric current from a power source denoted at 175 in FIG. 4. An electric current is preferably applied to electrode structure 90 at either or both of outermost plates 100 and 105 as will be presently described. Power source 175 is electrically connected to electrode structure 90 with electric wires 176A and 176B electrically connected between power source 175 and, according to a preferred embodiment, bolts 110 and 120 of fastener systems 107 and 108 electrically connected to tabs 100A and 105A of outermost plates 100 and 105, which form electrodes of apparatus 20. Ends of electric wires 176A and 176B are connected to bolts 110 and 120, respectively, preferably by positioning and capturing the ends of wires 176A and 176B between nuts 118 and 128 and the respective washers 117 and 127. Preferably, the ends of wires 176A and 176B are wrapped about shanks 112 and 122, respectively, between nuts 118 and 128 and the respective washers 117 and 127 and nuts 118 and 128 are tightened securing the ends of wires 176A and 176B between nuts 118 and 128 and the respective washers 117 and 127. Alternatively, the ends of wires 176A and 176B may be soldered or welded to nuts 118 and 128 and/or to shanks 112 and 122 to electrically connect power source 175 to electrode structure 90.

Power source 175 provides electric power in the nature of an electric current, which is applied to and across outermost plates 100 and 105 via wires 176A and 176B, and bolts 118 and 128 of fastener systems 107 and 108, in which fastener systems 107 and 108 are considered electric leads connected to wires 176A and 176B, respectively, to conduct electric current applied to wires 176A and 176B from power source 175 to outermost plates 100 and 105 of electrode structure 90. In this embodiment, wire 176A provides a positive charge and wire 176B provides a negative charge, and this can be reversed if so desired. Power source 175 is preferably a 12-volt power source, and is a battery 177 in one embodiment providing the positive and negative charges to wires 176A and 176B, such as the existing vehicle battery of a vehicle incorporating an internal combustion engine, an alternator 178 in another embodiment to provide the positive and negative charges to wires 176A and 176B, such as the vehicle alternator of a vehicle incorporating an internal combustion engine, or other like or similar power source. According to the invention, therefore, power source 175 is preferably the 12-volt power system of the vehicle incorporating the internal combustion engine.

And so with an electric current applied to outermost plates 100 and 105 of electrode structure 90, in which the positive charge or side of the current is applied to plate 100 and the negative charge or side of the current is applied to plate 105, solution allows electrical conductivity between plates 100-105 such that electrode structure is electrically charged or otherwise energized in solution 170 generating electrolysis in solution 170 to produce hydrogen gas that passes into void 171 from solution 170 in the direction indicated by the arrowed line A in FIG. 5. In accordance with the principle of the invention, a fuel supply line of an internal combustion engine is coupled in gaseous communication with void 171 to receive the hydrogen gas from void 171 and apply the hydrogen gas to fuel flowing through the fuel supply line to condition the fuel with the hydrogen gas to provide hydrogen gas conditioned fuel to improve the gas mileage of the internal combustion engine.

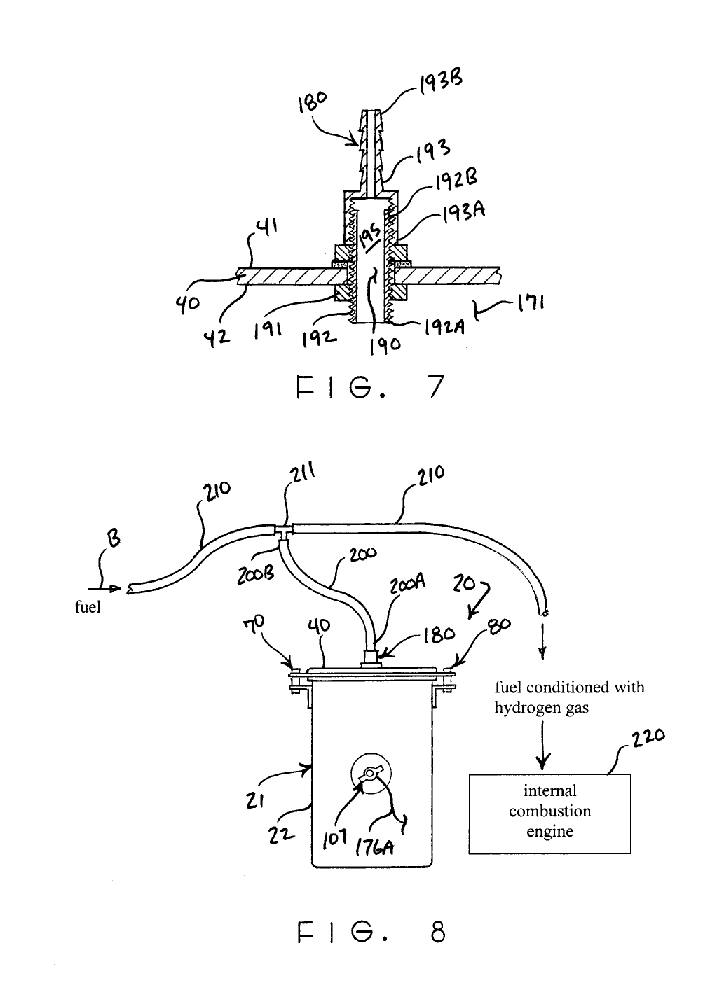

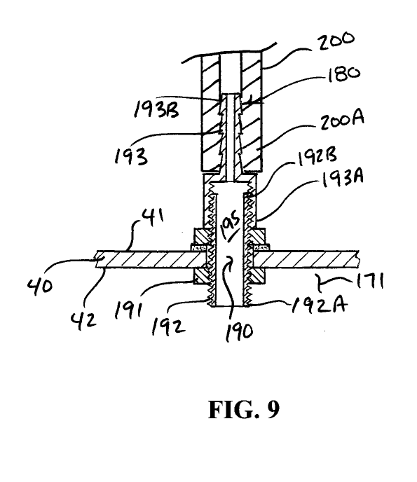

The fuel supply line is coupled in gaseous communication with void 171 with an outlet denoted generally at 180 in FIGS. 1-3 and 5 that, in the present embodiment, is formed in the closed upper end of enclosure 21 formed by top 40. Referencing FIG. 7, which is a section view taken along line 7-7 of FIG. 2, outlet 180 is formed in top 40, and consists of an opening 190 formed through top 40 between outer surface 41 and inner surface 42. A threaded grommet 191 is fitted through opening 190, and a threaded fitting 192 is fitted through grommet 191 and is threaded to grommet 191. Fitting 192 has an inner end 192A extending away from inner surface 42 into void 171, and an opposed outer end 192B extending away from outer surface 41 onto which is threaded and tightened an inner end 193A of a nozzle 193 having an opposed outer end 193B. Fitting 192 and nozzle 193 cooperate to form a gas flow pathway 195 of outlet 180 extending from inner end 192A of fitting 192 to opposed outer end 193B of nozzle 193. To couple a fuel supply line of an internal combustion engine in gaseous communication with void 171, an inner end 200A of a gas conduit or line 200 is fitted over outer end 193B of nozzle 193 as seen in FIG. 9, which, with reference to FIG. 8, extends outwardly to an outer end 200B coupled in gaseous communication to a fuel supply conduit or line 210 with a fitting 211.

Fuel supplied from a gas tank (not shown) of a vehicle incorporating an internal combustion engine travels through fuel supply line supply line 210 in the direction indicated by arrowed line B to internal combustion engine 220 for combustion in the cylinder assemblies of internal combustion engine 220 in the normal manner. Hydrogen gas generated by electrolysis in receptacle 30 by apparatus 20 according to the principle of the invention passes from void 171 through outlet 180 in the direction indicated by the arrowed line C in FIGS. 5 and 9 through pathway 195 referenced in FIG. 9 and into inner end 200A of hydrogen gas line 200. The hydrogen gas passes through hydrogen gas line 200 from inner end 200A to outer end 200B and is applied to the fuel passing through fuel supply line 210, where the hydrogen gas mixes with the fuel conditioning the fuel with the hydrogen gas to produce hydrogen gas-conditioned fuel, in accordance with the principle of the invention. This hydrogen gas-conditioned fuel combusts more efficiently and completely compared to fuel not so conditioned with hydrogen gas thereby increasing the gas mileage of internal combustion engine 220, in accordance with the principle of the invention. Because this hydrogen gas-conditioned fuel combusts more efficiently and completely compared to fuel not so conditioned with hydrogen gas, the gas mileage of an internal combustion engine running on fuel conditioned with hydrogen gas can be increased by approximately 20-30 percent as compared to the gas mileage of the same engine running on fuel not so conditioned with hydrogen gas, in accordance with the principle of the invention.

The amount of hydrogen gas generated by apparatus 20 and applied from apparatus 20 to the fuel in fuel line 210 to produce the hydrogen gas-conditioned fuel is an amount sufficient to produce increased gas mileage in internal combustion engine 220, in accordance with the principle of the invention. Preferably, as a matter of example, solution 170 is provided in apparatus 20 a volume amount of approximately one (1) liter, and the resulting electrolysis as herein described produces approximately 0.10 kilograms of hydrogen gas per liter of solution 170 per second for application to the fuel flowing through fuel line 210 via hydrogen gas line 200 that is coupled in gaseous communication to void 171. Apparatus 20 operates in conjunction with the operation of internal combustion engine 220. In the operation of internal combustion engine 220 and apparatus 20, the operation of apparatus 20 applies approximately 0.10 kilograms of hydrogen gas per second to the fuel flowing through fuel line 210 to produce the hydrogen gas-conditioned fuel that results in the increase in gas mileage in internal combustion engine 220 of approximately 20-30 percent as compared to the gas mileage of the same engine running on fuel not so conditioned with hydrogen gas, in accordance with the principle of the invention.

Because apparatus 20 operates in conjunction with the operation of internal combustion engine 220, apparatus 20 is preferably mounted to the vehicle incorporating internal combustion engine 220, such as in the engine compartment or other desired location. Accordingly, during the operation of internal combustion engine 220 apparatus 20 is operational and generates hydrogen gas that is continuously applied to the fuel passing through fuel supply line 210 to produce a continuous supply of hydrogen gas-conditioned fuel for combustion in the cylinder assemblies of internal combustion engine 220 for the purpose of improving the gas mileage of internal combustion engine 220. As apparatus 20 generates the hydrogen gas through electrolysis as shown and described, a positive pressure build-up of hydrogen gas forms in void 171 thereby forcibly applying the hydrogen gas through outlet 180 for application to the fuel passing through fuel supply line 210. Power source 175 referenced in FIG. 4 is preferably incorporated with the vehicle incorporating the internal combustion engine. In this example, battery 177 forming power source 175 in one embodiment can be the existing engine battery of the vehicle, and alternator 178 forming power source 175 in another embodiment can be the existing alternator of the vehicle.

Over time, solution 170 in enclosure 21 will need to be replenished. To do this, top 40 may be removed, solution 170 replenished, and then top 40 reattached. The ability to remove and reattach top 40 allows top 40 to be removed for not only replenishing solution 170, but also for cleaning, maintenance, and replacement of any broken parts.

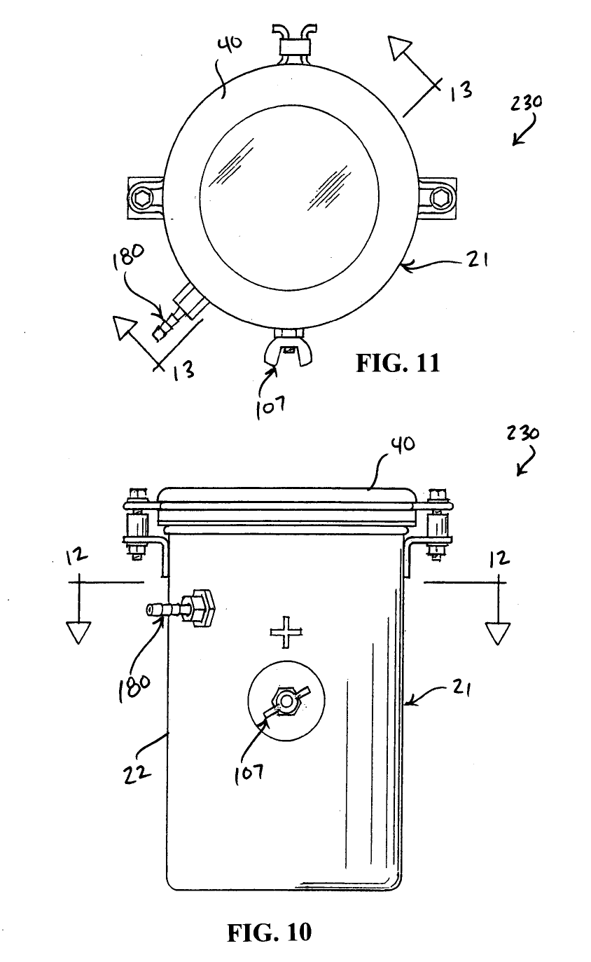

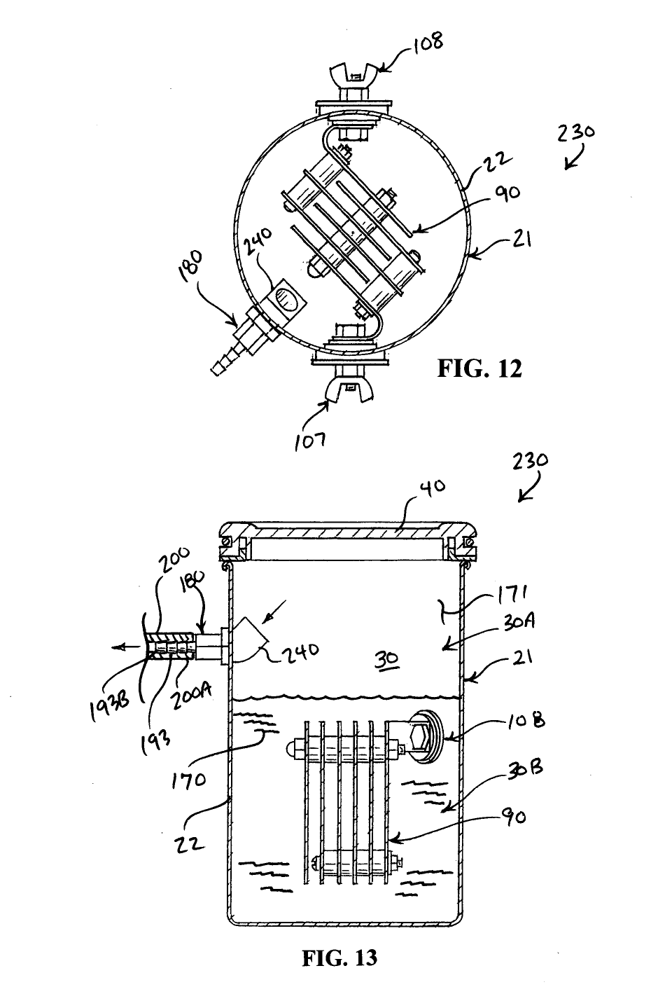

Outlet 180 is coupled in gaseous communication with void 171 at top 40 to receive hydrogen gas from void 171 for application to the fuel passing through a fuel line. Outlet 180 can be formed at other locations with respect to enclosure 21 so as to be coupled in gaseous communication with void 171. An example of an alternate placement of outlet 180 is demonstrated in connection with an alternate embodiment of an apparatus 230 for conditioning fuel hydrogen gas to produce hydrogen gas-conditioned fuel to increase the gas mileage of an internal combustion engine as illustrated in FIGS. 10-13, in which FIG. 10 is a side elevation view of apparatus 230, FIG. 11 is a top plan view of apparatus 230, FIG. 12 is a section view taken along line 12-12 of FIG. 10, and FIG. 13 is a section view taken along line 13-13 of FIG. 11. Referencing FIGS. 10-13 in relevant part, in common with apparatus 20, apparatus 230 shares enclosure 21 including top 40 and the fastening system attaching top 40, receptacle 30 formed in enclosure 21, electrode structure 90 attached in place in receptacle 30 with fastening systems 107 and 108, solution 170 and void 171 formed in upper and lower regions 30A and 30B of receptacle 30, and all related elements including outlet 180. The only difference between apparatus 20 and apparatus 230 is the placement of outlet 180, which, in apparatus 230, is at sidewall 22 opposing void 171. In apparatus 230, outlet 180 is formed at sidewall 22 in gaseous communication with void 171 proximate to the closed upper of enclosure 21 formed by top 40 at upper region 30A of receptacle opposing solution 170 formed in lower region 30B of receptacle 21 as best seen in FIG. 13. FIG. 13 illustrates inner end 200A of fuel supply line 200 coupled to outlet 180 at outer end 193B of nozzle 193 in the manner precisely as previously described in connection with FIG. 9. The only other difference between apparatus 20 and apparatus 230 is that outlet 180 is formed with a shield 240 illustrated in FIGS. 12 and 13, which extends into void 171 from sidewall 22 and which, as best seen in FIG. 13, extends upwardly toward the closed upper end of enclosure 21 formed by top 40 and away from solution 170 to inhibit solution 170 from spilling into outlet 180.

The invention has been described above with reference to preferred embodiments. However, those skilled in the art will recognize that changes and modifications may be made to the embodiments without departing from the nature and scope of the invention. Various changes and modifications to the embodiment herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. An apparatus for conditioning fuel, comprising:
an enclosure maintains a void, an opposed volume of an electrolytic solution, and an electrically charged electrode structure positioned in the volume of the electrolytic solution generating electrolysis in the electrolytic solution to produce hydrogen gas that passes into the void from the electrolytic solution; and
a fuel supply line of an internal combustion engine coupled in gaseous communication with the void to receive the hydrogen gas from the void and apply the hydrogen gas to fuel flowing through the fuel supply line to condition the fuel with the hydrogen gas.

2. An apparatus for conditioning fuel according to claim 1, wherein the enclosure comprises an upstanding, continuous sidewall having a closed upper end and an opposed closed lower end that cooperate to form an enclosed chamber defining an upper region proximate to the upper end and an opposed lower region proximate to the lower end, wherein the void is formed in the upper region of the enclosed chamber and the volume of the electrolytic solution is formed in the lower region of the enclosed chamber.

3. An apparatus for conditioning fuel according to claim 2, wherein the electrode structure is attached to the upstanding continuous sidewall, and is suspended in the volume of the electrolytic solution.

4. The apparatus for conditioning fuel according to claim 3, wherein the electrode structure comprises a plurality of interconnected and electrically isolated, spaced apart, substantially parallel conductive plates.

5. An apparatus for conditioning fuel according to claim 3, wherein the fuel supply line is coupled in gaseous communication with the void with an outlet formed in the continuous sidewall proximate to the closed upper end of the enclosure, and a hydrogen gas line coupled between the outlet and the fuel supply line to receive the hydrogen gas from the void via the outlet and convey the hydrogen gas to the fuel supply line.

6. An apparatus for conditioning fuel according to claim 5, wherein the outlet is formed with a shield extending into the void from the upstanding, continuous sidewall, which extends upwardly toward the closed upper end of the enclosure and away from the volume of the electrolytic solution to inhibit the electrolytic solution from spilling into the outlet.

7. An apparatus for conditioning fuel according to claim 3, wherein the fuel supply line is coupled in gaseous communication with the void with an outlet formed in the closed upper end of the enclosure, and a hydrogen gas line coupled between the outlet and the fuel supply line to receive the hydrogen gas from the void via the outlet and convey the hydrogen gas to the fuel supply line.

8. An apparatus for conditioning fuel according to claim 7, wherein the closed upper end is formed by a lid removably secured to the upstanding, continuous sidewall.

9. A method of conditioning fuel, comprising:
providing source of hydrogen gas; and
coupling a fuel supply line of an internal combustion engine in gaseous communication with the source of hydrogen gas to receive hydrogen gas from the source of hydrogen gas and apply the hydrogen gas to fuel flowing through the fuel supply line to condition the fuel with the hydrogen gas.

10. A method of conditioning fuel according to claim 9, wherein the step of providing the source of hydrogen gas comprises providing an enclosure maintaining a void and an opposed volume of an electrolytic solution, and an electrically charged electrode structure positioned in the volume of the electrolytic solution generating electrolysis in the electrolytic solution to produce hydrogen gas that passes into the void from the electrolytic solution.

11. A method of conditioning fuel according to claim 10, wherein the step of coupling the fuel supply line of the internal combustion engine in gaseous communication with the source of hydrogen gas to receive the hydrogen gas from the source of hydrogen gas and apply the hydrogen gas to fuel flowing through the fuel supply line comprises coupling the fuel supply line of the internal combustion engine in gaseous communication with the void to receive the hydrogen from the void and apply the hydrogen gas to fuel flowing through the fuel supply line.

12. A method of conditioning fuel according to claim 11, wherein the enclosure is an upstanding, continuous sidewall having a closed upper end and an opposed closed lower end that cooperate to form an enclosed chamber defining an upper region proximate to the upper end and an opposed lower region proximate to the lower end, wherein the void is formed in the upper region of the enclosed chamber and the volume of the electrolytic solution is formed in the lower region of the enclosed chamber.

13. A method of conditioning fuel according to claim 12, wherein the electrode structure is attached to the upstanding continuous sidewall, and is suspended in the volume of the electrolytic solution.

14. A method of conditioning fuel according to claim 13, wherein the electrode structure comprises a plurality of interconnected and electrically isolated, spaced apart, substantially parallel conductive plates.

15. A method of conditioning fuel according to claim 11, wherein the step of coupling the fuel supply line of the internal combustion engine in gaseous communication with the void to receive the hydrogen from the void and apply the hydrogen gas to fuel flowing through the fuel supply line further comprises:
forming an outlet in the continuous sidewall proximate to the closed upper end of the enclosure; and
coupling the outlet to the fuel supply line in gaseous communication with a hydrogen gas line to receive the hydrogen gas from the void via the outlet and convey the hydrogen gas to the fuel supply line.

16. A method of conditioning fuel according to claim 15, further comprising forming the outlet with a shield extending into the void from the upstanding, continuous sidewall, which extends upwardly toward the closed upper end of the enclosure and away from the volume of the electrolytic solution to inhibit the electrolytic solution from spilling into the outlet.

17. A method of conditioning fuel according to claim 11, wherein the step of coupling the fuel supply line of the internal combustion engine in gaseous communication with the void to receive the hydrogen from the void and apply the hydrogen gas to fuel flowing through the fuel supply line further comprises:
forming an outlet in the closed upper end of the enclosure; and
coupling the outlet to the fuel supply line in gaseous communication with a hydrogen gas line to receive the hydrogen gas from the void via the outlet and convey the hydrogen gas to the fuel supply line.
